(19) United States
(12) Patent Application Publication
(10) Pub. No.: US 2004/0133658 A1
(43) Pub. Date: Jul. 8, 2004

(54) Identification of electronic resources

(76) Inventor: Werner Kunze, Dusseldorf (DE)

Correspondence Address: WILLIAM COLLARD, COLLARD & ROE, P.C., 1077 NORTHERN BOULEVARD, ROSLYN, NY, 11576, US

(21) Appl. No.: 10/470,911

(22) PCT Filed: Jan. 23, 2002
(86) PCT No.: PCT/EP02/00629

(51) Int. Cl. G06F 17/30

(52) U.S. Cl. 709/219; 709/245

(57) ABSTRACT

The invention relates to a method for requesting and transmitting electronic resources via a data network. A web server operating according to said method interprets the URL path of a query inputted by a client as identification information, which is independent of the physical storage site of the requested web page. In order to find the requested web page, the identification information is assigned to the physical storage site in the server. To this end, the web server uses a databank in which the physical storage site for web pages made available by the server and a character string serving as identification information are stored. The inventive method makes it possible to use short content-related and easy-to-note URLs which are persistent due to the independence from the physical storage site.

The invention relates to a method for requesting and transmitting electronic resources via a data network, whereby a query that contains a character string for identification of an electronic resource is transmitted from a client computer to a server computer, via the data network, and whereby the electronic resource assigned to the identification information is transmitted as a response to the query, from the server computer to the client computer.

Access to a wide variety of different information sources distributed worldwide is made possible by the Internet and, in particular, by the World Wide Web. The most important components of the World Wide Web are the individual information parts or information resources (mostly web sites), on the one hand, and the links between them, on the other hand, which connect the individual information parts into a network of information resources. The electronic information resources are kept available for call-up by web servers connected to the Internet. In order to access the information resources, a mechanism is needed that makes it possible to clearly identify the electronic resources distributed in the Internet.

Such a mechanism is available with the use of URLs (Uniform Resource Locators) for identification of electronic resources in the Internet. The syntax of the URLs is established in the Internet Proposed Standards RFC1738 and 1808. In general, a URL consists of system information and a system-specific part. A URL, such as it is input by a user to call up a specific web site by means of a browser program, for example, usually has the following form:

http://servername/path

The first component of this URL indicates the Schema that is being used in order to access information via the Internet. In this case, these are information resources that are available via the Hypertext Transfer Protocol (HTTP). Usually, a so-called Fully Qualified Domain Name is used as the server name, and it is assigned to an Internet address by means of the Domain Name Service (DMS [sic]). The last component of the URL is the so-called URL path, which indicates the physical storage location of the electronic resource on the server computer. This is, for example, the path within the directory structure of the file system, under which a specific web site is stored on the server.

The use of URLs as described has a number of disadvantages. In particular, if a large number of web sites is made available by a web server, and these are stored in memory in a directory structure that is deeply staggered and highly interlaced, the URL paths assigned to the individual web sites become very long and are therefore complicated to remember. The URLs thereby become useless to the user for direct access to the desired web sites. In this case, it is possible to reach the desired information resources only by way of a plurality of links, by means of which the web sites are linked with one another on the server, and this is very time-consuming and therefore disadvantageous.

Another disadvantage results from the fact that static identification takes place by means of the URLs described above. Larger web servers, in particular, require regular maintenance work. With the constant increase in the number of files stored on the server, a reorganization of the directory structure becomes necessary on a regular basis. Files are relocated, renamed; obsolete files are deleted. This has the result that the URL path information is no longer valid after a certain period of time. The URLs are therefore not suited for use, over an extended period of time, to access the electronic resources in the Internet, and this is a disadvantage.

Web servers increasingly use database systems for storage and maintenance of electronic resources. Access to the data stored in the database, by means of a URL, is extremely inconvenient for a user, since the data can be called up only via a special interface to the database. For this purpose, so-called dynamic URLs can be used, whereby in addition to the path information, additional identification information is required in the URL. Such dynamic URLs have an extremely complicated structure, are very long, and a user finds it almost impossible to remember them.

The present invention is based on the task of making a method available with which the electronic resources in the Internet can be identified efficiently and as easily as possible, while avoiding the stated disadvantages.

This task is accomplished, for a method of the type stated initially, in that the identification information is independent of the physical storage location of the electronic resource being requested and that an assignment of the identification information to the physical storage location takes place in order to find the electronic resource on the server computer.

The method according to the invention is based on the idea of using a character string for identification, which string is independent of the physical storage location of the electronic resource being requested. According to the invention, the path information of the conventional URLs is replaced by a designation that preferably has a content reference to the desired data, so that this designation is easy for the user to remember. It is particularly advantageous that the character string used for this purpose can be short, specifically even if large amounts of data are made available by a web server.

Furthermore, it is advantageous that such character strings can be passed on in writing, by telephone, or in other manner, more easily than the URLs currently in use.

The method according to the invention is particularly suitable for uses in e-commerce. The character string used as the identification information can be the description or order number of a product, for example, for which access to the web sites containing the related product descriptions takes place.

Because of the independence of the identification information from the physical storage location of the electronic resource, the advantage results that the identification information has a long persistence, even if the corresponding files on the web server are renamed or shifted in the directory structure.

It is particularly advantageous that the method according to the invention can already be implemented at the present time, without any problems, whereby no changes are evident to the user who accesses an electronic resource from a client computer. For example, as described above, it is possible to use the path information contained in the conventional URLs as a character string for identification of an electronic resource according to the invention. The URL path is then interpreted as identification information on the server computer, and the related physical storage location of the requested electronic resource is then determined for this identification information. The method according to the invention therefore requires an adaptation of the web server program running on the server computer, so that identification information transmitted by a client computer as a URL path can be processed even if this information merely contains a short and easy-to-remember content-related character string instead of the physical storage location of the desired electronic resource.

An advantageous further development of the method according to the invention results if a database is used for assigning the identification information to the physical storage location of the electronic resource, in which database the physical storage location of the electronic resources made available by the server computer, in each instance, and at least one character string as the identification information, are stored. By means of the database, every electronic resource made available by the server computer can have one or more character strings assigned to it as identification information, in particularly simple manner. In order to find the physical storage location, it is merely necessary to search for the queried character string in the database. For example, a content-related short description can be stored on a web server for every web site in the database, which description can then be used by Internet users to call up the sites in question. In this connection, the data content of the database can be updated automatically, at regular intervals, or as needed, so that the current physical storage location, namely the complete path information of the web sites stored on the web server, and the assignment of the related identification information are in agreement. It is advantageous that commercially available databases are easily suited for use on web servers, to implement the method according to the invention.

Alternatively, it is also possible that assignment of the identification information to the physical storage location takes place in that the electronic resources made available by the server are searched using the identification information as a search word. In this case, the character string, which is transmitted to the server computer as a URL path, for example, is interpreted as a search word, for which the data content of the web server is searched. In this way, a search function can be utilized by the user, per URL, in order to call up a web site, for example, that contains a certain key term. In this connection, there is also the possibility of using search algorithms that find not only identical but also similar terms, in order to achieve a greater tolerance for typographical errors. In this variant of the method according to the invention, the identification information is not unambiguous, if necessary, namely if the character string in question is present in the data content of the server computer several times. It is possible, in this case, to transmit a search result containing a listing of several possible web sites to the client computer in response to the query.

For the method according to the invention, it is practical to use a browser program on the client computer by way of which a user makes the request for the electronic resource, by inputting a query that is composed of the designation of the server computer and a character string for identification of the electronic resource made available by the server computer. This makes it possible to use conventional URLs for the identification of electronic resources according to the invention. The indication of the server name remains the same as in the conventional method; only the path information is no longer used to designate the physical storage location of the requested electronic resource, but rather at least partially as identification information according to the invention, to which the related physical storage location is then assigned on the server side. If the method is used, as described above, to search the data content of the web server for a specific key term, the fact that the path information is kept in the URL makes it possible to limit the search to specific subdirectories of the server computer and thereby to accelerate the search.

If an assignment of the identification information to the physical storage location on the server computer is not possible with the method according to the invention, it is practical, as a further development of the method according to the invention, to transmit a search form to the client computer, by way of which a search word for searching for the requested electronic resource can be input. In this way, it can be avoided that the user of the client computer merely receives an error message. Instead, the user is given the opportunity to conduct a search in the data content of the queried server computer, in order to find the desired electronic resource.

A computer program for a web server, in which a character string is extracted from a query that is received from a client computer, via a data network, which string designates an electronic resource made available by the web server, is suitable for carrying out the method according to the invention; access to a database then takes place, in which database identification information is assigned to the electronic resources made available by the web server, whereby the physical storage location of the requested electronic resource whose identification information agrees with the extracted character string is determined, so that access to transmit the requested electronic resource to the client computer can take place.

It is advantageous if a web server in the Internet is equipped with such a computer program, so that the electronic resources made available by the web server can be called up according to the invention. The query received from a client computer contains the URL, whose path component can be interpreted as a character string, to which the physical storage location of the requested electronic resource is assigned by means of the database. It is therefore possible, in simple manner, as described above, to make content-related identification information for the web sites made available on a web server available to the Internet user.

Exemplary embodiments of the invention will be explained in the following, using the figures. These show:

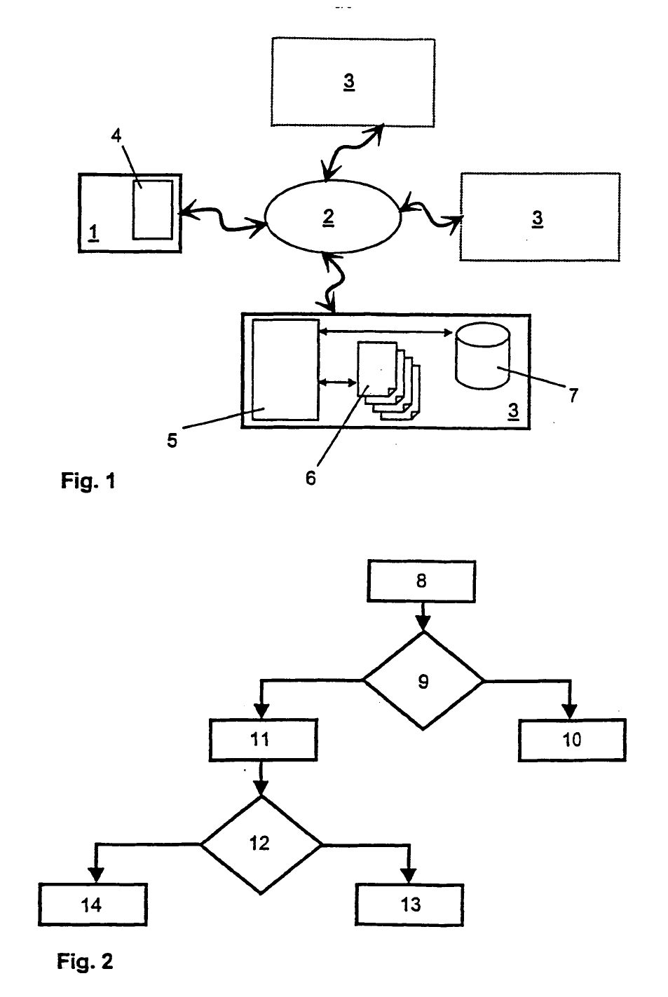

FIG. 1 a schematic view of a data network having client and server computers;

FIG. 2 a block schematic of the method according to the invention.

FIG. 1 shows a client computer 1 that is connected with a data network 2 (Internet). The client computer 1 can access different server computers 3 via the data network 2. A browser program 4 runs on the client computer 1, for requesting and transmitting electronic resources via the data network 2. A web server program 5 runs on the server computers 3, for processing the queries of the client computer 1. A plurality of web sites 6 are stored on the server computer 3, and can be called up by the client computer 1 by means of the browser 4. According to the invention, a query is transmitted by the client computer 1 to the server computer 3, via the data network 2, which query contains a character string for identification of a web site 6. This identification information is independent of the physical storage location of the web site 6. In order to find the web site 6, an assignment of the identification information to the physical storage location of the web site 6 is carried out on the server computer 3. A database 7 that is present on the server computer 3 is used for this purpose. For the web sites 6 made available by the server computer 3, at least one character string is stored in the database 7 as identification information. The web server 5 searches the database 7 for the character string transmitted by the client computer 1, and thereby determines the physical storage location of the requested web site 6. The latter can then be transmitted to the client computer 1 by the server computer 3, via the data network 2, and can be displayed using the browser 4.

FIG. 2 shows a flow chart according to which a computer program works for a server computer in order to implement the method according to the invention. The program starts with the query 8, which is received by the server 3 from a client computer 1, via a data network. First, in step 9, the program checks whether the path information of a URL contained in the query reproduces the physical storage location of a web site 6 that is present on the server 3. If this is the case, the web site 6 in question is transmitted to the client computer 1 as an answer to the query in step 10. If the path information in the URL cannot be assigned to the physical storage location of a web site 6, the URL path is extracted from the query that was received, and interpreted as identification information, which, according to the invention, is independent of the physical storage location of the requested web site 6, in step 11. In step 12, access to a database 7 takes place, which contains identification information for the web sites 6 made available by the server 3. If a web site that is assigned to the identification information can be determined by means of the database 7, the web site in question is transmitted to the client computer via the data network 7 in Step 13. Otherwise, in step 14 a search form is transmitted, so that the user of the client computer 1 is given the opportunity to specify his/her query further.

1. Method for requesting and transmitting electronic resources (6) via a data network (2), whereby a query that contains a character string for identification of an electronic resource (6) is transmitted from a client computer (1) to a server computer (3), via the data network (2), and whereby the electronic resource (6) assigned to the identification information is transmitted as a response to the query, from the server computer (3) to the client computer (1), characterized in that the identification information is independent of the physical storage location of the electronic resource (6) being requested, and that an assignment of the identification information to the physical storage location takes place in order to find the electronic resource (6) on the server computer (3).

2. Method according to claim 1, characterized in that a database (7) is used for assigning the identification information to the physical storage location of the electronic resource (6), in which database the physical storage location of the electronic resources (6) made available by the server computer (3), in each instance, and at least one character string as the identification information, are stored.

3. Method according to claim 1, characterized in that assignment of the identification information to the physical storage location takes place in that the electronic resources made available by the server are searched using the identification information as a search word.

4. Method according to claim 1, characterized in that a browser program (4) is used on the client computer (1), by way of which a user makes the request for the electronic resource (6), by inputting a query that is composed of the designation of the server computer (3) and a character string for identification of the electronic resource (6) made available by the server computer (3).

5. Method according to claim 1, characterized in that the server computer (3) transmits a search form to the client computer (1), by way of which a search word for searching for the requested electronic resource (6) can be input, if an assignment of the identification information to the physical storage location on the server computer is not possible.

6. Computer program for a web server, for implementing the method according to claim 1, characterized in that a character string is extracted from a query that is received from a client computer, via a data network, which string designates an electronic resource made available by the web server, whereupon access to a database takes place, in which database identification information is assigned to the electronic resources made available by the web server, whereby the physical storage location of the requested electronic resource whose identification information agrees with the extracted character string is determined, so that access to transmit the requested electronic resource to the client computer can take place.
